(19) United States
(12) Patent Application Publication
(10) Pub. No.: US 2015/0170480 A1
(43) Pub. Date: Jun. 18, 2015

(54) STRUCTURE OF LIGHT EMITTING CLIP BUTTON

(71) Applicant: KING'S METAL FIBER TECHNOLOGIES CO., LTD., TAICHUNG CITY (TW)

(72) Inventors: RENG-SHO CHEN, TAIPEI CITY (TW); HONG-HSU HUANG, TAIPEI CITY (TW); I-CHEN SU, TAIPEI CITY (TW)

(73) Assignee: KING'S METAL FIBER TECHNOLOGIES CO., LTD., TAICHUNG CITY (TW)

(21) Appl. No.: 14/104,043

(22) Filed: Dec. 12, 2013

(51) Int. Cl. G08B 5/00; F21V 23/06; F21V 33/00; F21K 99/00

(52) U.S. Cl. CPC G08B 5/004; F21K 9/50; F21K 9/30; F21V 23/06; F21V 33/0076; F21Y 2101/02

(57) ABSTRACT

A structure of a light-emitting clip button includes an upper body, a circuit board, a lower body, and a connection piece. The upper body has at least one first engagement section. The circuit board is arranged in the upper body and has at least one light-emitting element and two conductive pins. The light-emitting element is electrically connected to an end of each of the conductive pins. The lower body has two coupling troughs and at least one second engagement section. Each coupling trough is engageable with the respective conductive pin. The first engagement section is engageable with the second engagement section. The connection piece connects the upper body and the lower body.

### FIELD OF THE INVENTION

The present invention relates to a structure of a light-emitting clip button, and in particular to a structure of a light-emitting clip button applicable to clothing.

### BACKGROUND OF THE INVENTION

Clothing is a necessary daily article for human living. Since clothing is put on a human body and is moved with the human body, light reflected by the clothing provides an easy observation of the existence of the human body or the activities thereof. For example, a nighttime worker may put on clothing or an accessory that provides an effect of light reflection to clearly indicate his or her location or a responding movement in the dark environment in order to ensure working safety of the people. Such light reflection techniques are most commonly used in road workers or cleaning personnel who often work in the nighttime. By wearing or carrying clothing that provides an effect of light reflection, they can be early identified by a driver at a substantial distance so that the driver may take proper actions to avoid potential traffic accidents.

The use of such clothing that reflects light in passive sense is effective in providing alarming for safety purposes, but the effect of securing safety may vary with environments that are different from each other and the persons to be protected so that there might be insufficiency for the security of safety. For example, such light-reflecting clothing is only effective when it is irradiated by an external source of light. A car that moves in a high speed may still collides the person wearing such clothing for the distance may be excessively short to allow the driver to react at the moment when the car light shortly irradiates the person or there may be simply of no way or no time for the car light to irradiate the person. Thus, such a passive light reflection technology applied to clothing may not be sufficient or effective to meet the needs for securing safety in various environments.

In view of such problems, the present invention aims to provide a structure of a light-emitting clip button that is applicable to clothing for realizing an active measure of light emission in various dark or nighttime environments.

### SUMMARY OF THE INVENTION

An object of the present invention is to provide a structure of a light-emitting clip button, particularly a structure of a light-emitting clip button applicable to clothing.

To achieve the above object, the present invention provides structure of a light-emitting clip button, which comprises: an upper body, a circuit board, a lower body, and a connection piece. The upper body comprises a first surface, a second surface, and a first side face. The first side face is circumferentially arranged and extending between the first surface and the second surface. The second surface comprises at least one first engagement section. The circuit board is arranged in the upper body. The circuit board comprises at least one light-emitting element and two conductive pins. The light-emitting element is electrically connected to an end of each of the conductive pins. Each of the conductive pins has an opposite end extending through the second surface and located adjacent to the first engagement section. The lower body comprises two coupling troughs and at least one second engagement section. Each of the coupling troughs is engageable with each of the conductive pins. The first engagement section is engageable with the second engagement section. The connection piece connects the upper body and the lower body.

In the above described structure of the light-emitting clip button, the first surface further comprises a through hole formed therein and the through hole is formed to correspond to and receive and retain the light-emitting element therein so as to allow the light-emitting element to emit light to transmit therethrough.

In the above described structure of the light-emitting clip button, a lens is further included, which is mounted in the through hole.

In the above described structure of the light-emitting clip button, the light-emitting element comprises a light-emitting diode.

In the above described structure of the light-emitting clip button, the first side face is of a concave curved cross-sectional shape to facilitate coupling of the coupling troughs with the respective conductive pins and the first engagement section is engageable with the second engagement section.

In the above described structure of the light-emitting clip button, each of the coupling troughs comprises a stepped section formed therein and the opposite end of each of the conductive pins comprises a protrusion section circumferentially surrounding thereon, wherein the protrusion section corresponds to and is tightly engageable with the stepped section.

In the above described structure of the light-emitting clip button, the first engagement section comprises a recessed cavity and the second engagement section comprises a raised block.

### BRIEF DESCRIPTION OF THE DRAWINGS

The present invention will be apparent to those skilled in the art by reading the following description of a preferred embodiment thereof with reference to the drawings, in which:

FIG. 1 is a perspective view of the present invention in an open condition;

FIG. 2 is an exploded view of the present invention in a closed condition;

FIG. 3 is a perspective view of the present invention in a closed condition;

FIG. 4 is a cross-sectional view taken along line A-A of FIG. 3;

FIG. 5 is a cross-sectional view taken along line B-B of FIG. 3;

FIG. 6 is a perspective view showing an application of the present invention; and

FIG. 7 is a cross-sectional view of FIG. 6.

### DETAILED DESCRIPTION OF THE PREFERRED EMBODIMENT

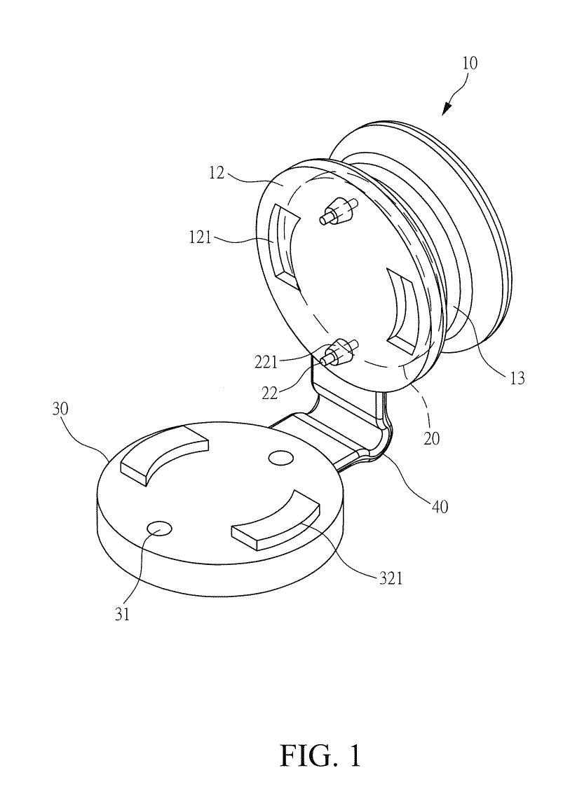

With reference to the drawings and in particular to FIGS. 1-5, the present invention provides a structure of a light-emitting clip button, which comprises: an upper body 10, a circuit board 20, a lower body 30, and a connection piece 40. The upper body 10 comprises a first surface 11, a second surface 12, and a first side face 13. The first side face 13 is circumferentially arranged and extending between the first surface 11 and the second surface 12. The second surface 12 comprises at least one first engagement section 121. The circuit board 20 is arranged in the upper body 10 and the circuit board 20 comprises at least one light-emitting element 21 and two conductive pins 22. The light-emitting element 21 is electrically connected to an end of each of the conductive pins 22. Each of the conductive pins 22 has an opposite end extending through the second surface 12 and located adjacent to the first engagement section 121. The lower body 30 comprises two coupling troughs 31 and at least one second engagement section 321 formed thereon. Each of the coupling troughs 31 corresponds to and mates each of the conductive pins 22. The first engagement section 121 corresponds to and engages with the second engagement section 321. The connection piece 40 connects between the upper body 10 and the lower body 30. Further, the connection piece 40, the upper body 10, and the lower body 30 can be integrally formed through injection molding or alternatively, the connection piece 40, the upper body 10, and the lower body 30 are manufactured separately and are then connected together.

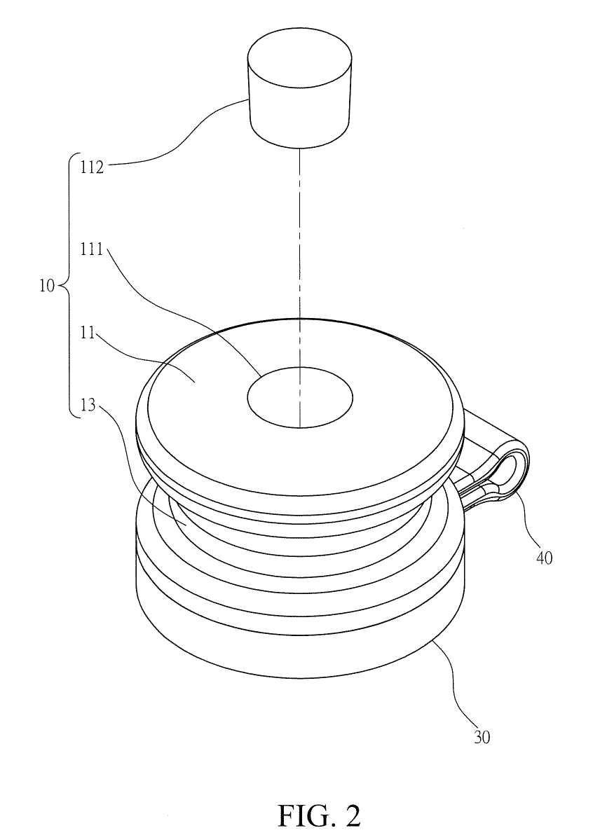

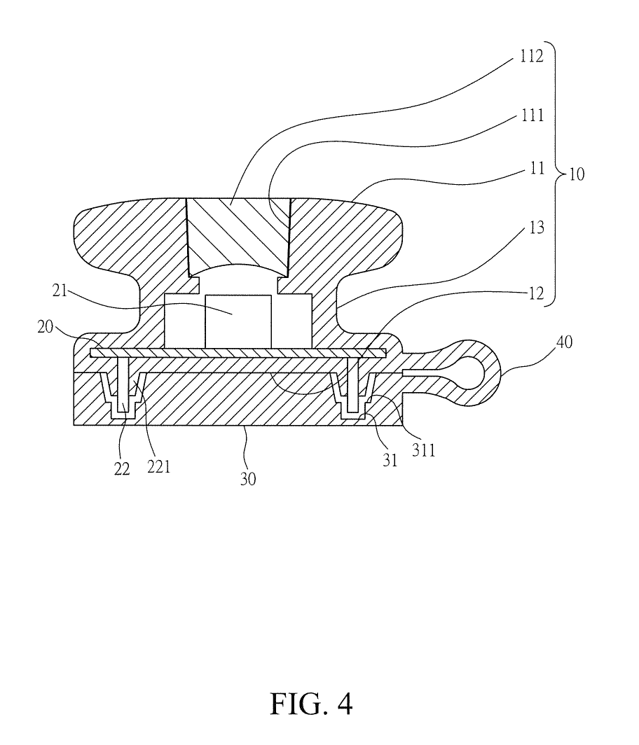

Referring to FIG. 2, is an exploded view of the present invention is shown, wherein the first surface 11 further comprises a through hole 111 formed therein and the through hole 111 is formed to correspond to and receive and retain the light-emitting element 21 (also see FIG. 4) therein so as to allow the light-emitting element 21 to emit light to transmit therethrough. Further, the through hole 111 further receives a lens 112 mounted therein so that when the light-emitting element 21 gives off light, the lens 112 can condense the light to provide a more prominent effect of the light. The light-emitting element 21 can be a light-emitting diode. The use of the light-emitting diode allows for reduction of the overall volume of the structure of the light-emitting clip button, making carrying convenient and providing an effect of saving power.

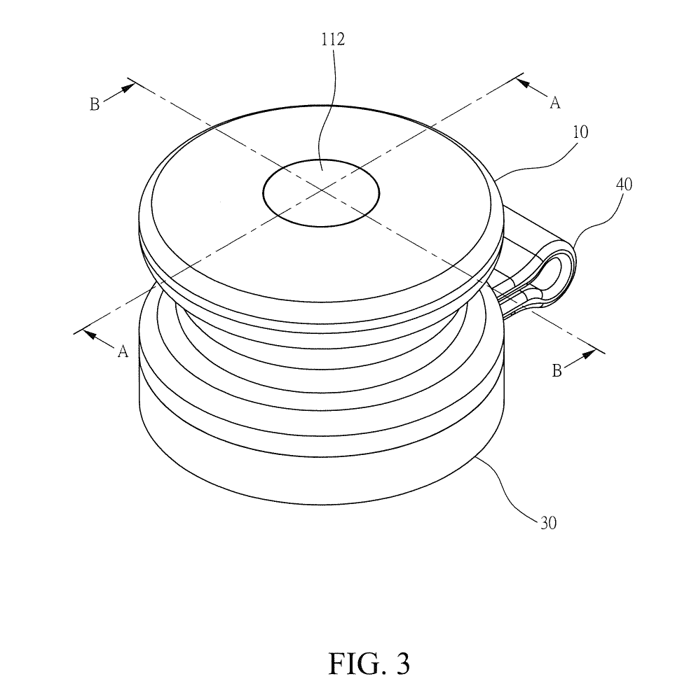

Further referring to FIGS. 3 and 4, of which FIG. 3 is a perspective view of the present invention in an assembled form and FIG. 4 is a cross-sectional view taken along line A-A of FIG. 3, the first side face 13 is of a concave curved cross-sectional shape to facilitate coupling of the coupling troughs 31 with the respective conductive pins 22. Each of the coupling troughs 31 comprises a stepped section 311 formed therein and the opposite end of each of the conductive pins 22 comprises a protrusion section 221 circumferentially surrounding thereon. The protrusion section 221 corresponds to and tightly mates the stepped section 311. An effect of water resistance can be achieved with the tight mating engagement between the protrusion section 221 and the stepped section 311.

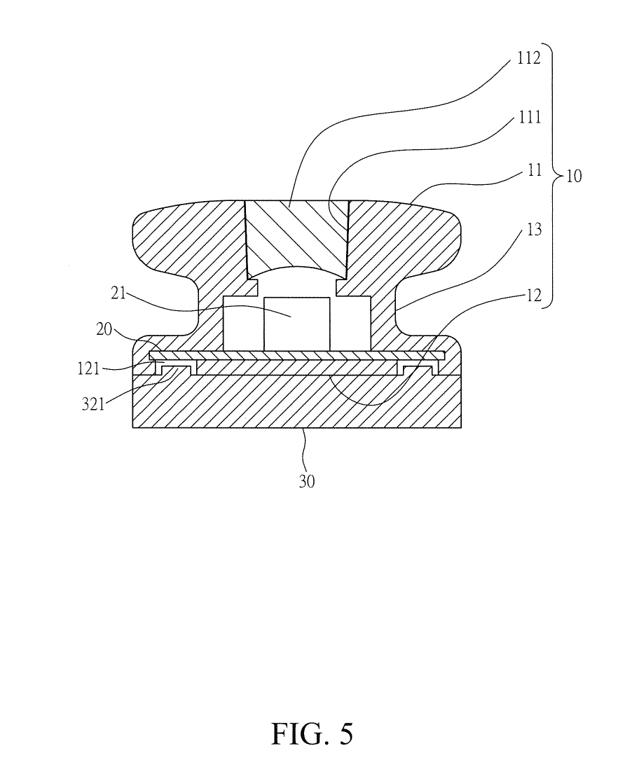

Further referring to FIGS. 3 and 5, of which FIG. 3 is a perspective view of the present invention in an assembled form and FIG. 5 is a cross-sectional view taken along line B-B of FIG. 3, the first engagement section 121 of the upper body 10 is a recessed cavity and the second engagement section 321 of the lower body 30 is a raised block, whereby the recessed cavity and the raised block are engageable with each other to provide an effect of positioning and secure coupling. The first side face 13 has a concave curved cross-sectional shape to ease application of an external force thereto so as to facilitate the first engagement section 121 engaging with the second engagement section 321, thereby achieving an effect of easy assembling and disassembling.

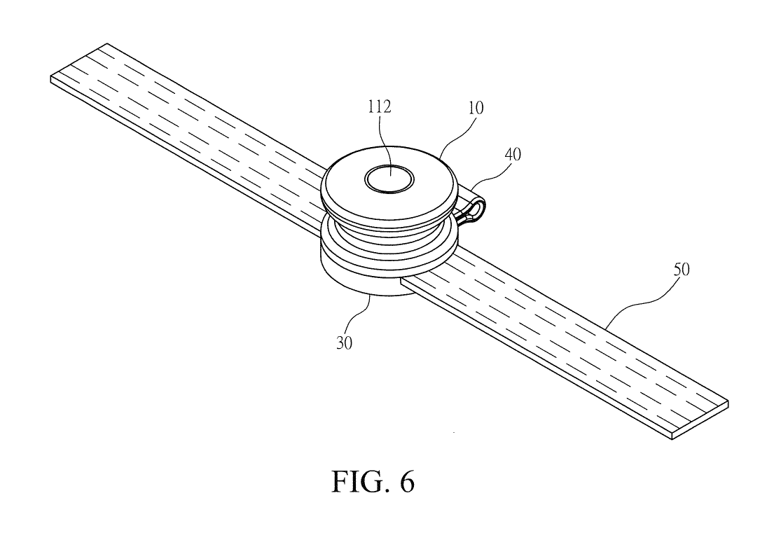

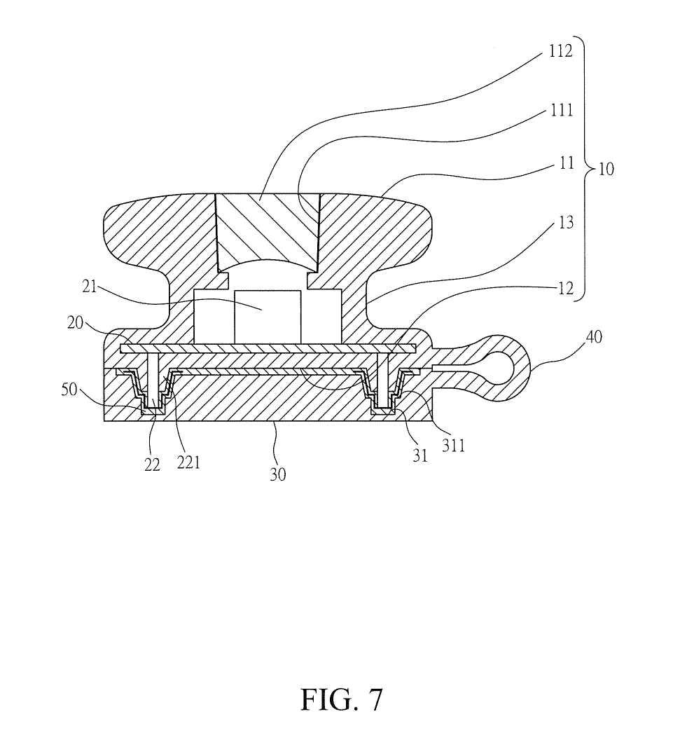

Finally, referring to FIGS. 6 and 7, of which FIG. 6 is a schematic view showing an application of the present invention and FIG. 7 is a cross-sectional view of FIG. 6, in the application, the structure of the light-emitting clip button according to the present invention is applied to clothing. The clothing comprises at least one conductive fabric 50 sewn thereto. The conductive fabric 50 comprises wires of positive and negative electrodes (as indicated by phantom lines of FIG. 6. The structure of the light-emitting clip button of the present invention is applied by having the upper body 10 and the lower body 30 clamp the conductive fabric 50 interposed therebetween so that the conductive pins 22 are set in electrical connection with the conductive fabric 50. When the conductive fabric 50 is electrically connected to a power supply, the electrical power so supplied flows sequentially through the conductive fabric 50, the conductive pins 22, and the light-emitting element 21 to energize the light-emitting element 21 for emission of light that transmits through the through hole 111 to project out. Alternatively, the through hole 111 may receive the lens 112 mounted therein to enable an even bettered luminous effect through a combination of the light emitting from the light-emitting element 21 and light refraction by the lens 112. The structure of the light-emitting clip button according to the present invention enables modularization for mass production and easing of manufacturing and also allows the upper body 10 and the lower body 30 to be fast set in mutual electrical connection with the conductive fabric 50 and securely coupled and positioned.

In summary, the features of the present invention are summarized as follows:

(1) The structure of the light-emitting clip button according to the present invention enables modularization for mass production and easing of manufacturing and also allows the upper body and the lower body to be fast set in mutual electrical connection with the conductive fabric and securely coupled and positioned.

(2) The first side face of the upper body of the present invention shows a concave curved configuration that facilitates the coupling troughs engaging the conductive pins and the first engagement section mating the second engagement section so as to provide an effect of easy assembling and disassembling.

(3) Each of the coupling troughs of the present invention comprises a stepped section formed therein and each of the conductive pins comprises a protrusion section circumferentially surrounding thereon so that the protrusion section is tightly engageable with the stepped section to provide an effect of water resistance.

(4) The first engagement section of the present invention is a recessed cavity and the second engagement section is a raised block, so that mating engagement between the recessed cavity and the raised block provides an effect of positioning and secured coupling.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A structure of a light-emitting clip button, comprising:
an upper body, which comprises a first surface, a second surface, and a first side face, the first side face circumferentially arranged and extending between the first surface and the second surface, the second surface comprising at least one first engagement section;
a circuit board, which is arranged in the upper body, the circuit board comprising at least one light-emitting element and two conductive pins, the light-emitting element being electrically connected to an end of each of the conductive pins, each of the conductive pins having an opposite end extending through the second surface and located adjacent to the first engagement section;
a lower body, which comprises two coupling troughs and at least one second engagement section, each of the coupling troughs being engageable with each of the conductive pins, the first engagement section being engageable with the second engagement section; and
a connection piece, which connects the upper body and the lower body.

2. The structure of the light-emitting clip button as claimed in claim 1, wherein the first surface further comprises a through hole formed therein and the through hole is formed to correspond to and receive and retain the light-emitting element therein so as to allow the light-emitting element to emit light to transmit therethrough.

3. The structure of the light-emitting clip button as claimed in claim 2 further comprising a lens, which is mounted in the through hole.

4. The structure of the light-emitting clip button as claimed in claim 2, wherein the light-emitting element comprises a light-emitting diode.

5. The structure of the light-emitting clip button as claimed in claim 1, wherein the first side face is of a concave curved cross-sectional shape to facilitate coupling of the coupling troughs with the respective conductive pins and the first engagement section is engageable with the second engagement section.

6. The structure of the light-emitting clip button as claimed in claim 1, wherein the first engagement section comprises a recessed cavity and the second engagement section comprises a raised block.

7. The structure of the light-emitting clip button as claimed in claim 1, wherein each of the coupling troughs comprises a stepped section formed therein and the opposite end of each of the conductive pins comprises a protrusion section circumferentially surrounding thereon, the protrusion section corresponding to and tightly engageable with the stepped section.

8. The structure of the light-emitting clip button as claimed in claim 1, wherein the light-emitting element comprises a light-emitting diode.
